(19) United States
(12) Patent Application Publication
(10) Pub. No.: US 2006/0265392 A1
(43) Pub. Date: Nov. 23, 2006

(54) Data management system, data server, and data management method

(76) Inventors: Akira Sunada, Kawasaki-shi (JP); Kazuki Yasumatsu, Kawasaki-shi (JP)

Correspondence Address: GAUTHIER & CONNORS, LLP, 225 FRANKLIN STREET, BOSTON, MA, 02110, US

(21) Appl. No.: 11/252,469

(22) Filed: Oct. 18, 2005

(30) Foreign Application Priority Data
May 20, 2005 (JP) 2005-147656

(51) Int. Cl. G06F 17/30

(52) U.S. Cl. 707/10

(57) ABSTRACT

In a data management system in which a data server cooperates with other data servers connected thereto via a network, each data server has a data management section in which one or more data items are stored in correspondence to globally unique data identifiers, a request processor section that searches the data management section for data item requested from a client, provides the requested data item to the client when the requested data item is found, and transmits a data inquiry to other data server on the network to detect a data server storing the requested data item when the requested data item is not found; and a response section that searches, when receiving a data inquiry transmitted from another data server, the data management section for the requested data item and transmits to the another data server a result of the search.

### BACKGROUND OF THE INVENTION

1. Field of the Invention

The present invention relates to a technique for resolving a location of data requested by a user.

2. Description of the Related Art

Conventionally, a data management system manages files by attaching to each file a unique identifier called a “handle.” The data management system provides to a user, as a URL (Uniform Resource Locator) of a file, not a URL showing the location (combination of a located server and a path name of the file within the server) of the file, which conventionally is commonly employed, but a virtual URL designating the server name of the system and the handle of the file. When the user accesses the system using the virtual URL, the system identifies the location of the file from the handle and provides the file to the user. With this mechanism, even when the file is moved to an arbitrary location (directory) on the data management system, the file can be found in response to a request from a user.

In another related art technique, a server attaches an identifier to each content item which is managed by the server and, when a user makes a request for search, provides to the user a virtual URL containing the identifier of the content matching the request. When the user accesses the server using the virtual URL, the server transfers the identifier contained in the virtual URL to a storage system. The storage system copies to a cache memory the content corresponding to the identifier and returns to the server an address of the copy of the content in the cache memory. In this manner, the server can provide the user with the content in the cache memory.

In a data management system “Dspace,” which is an open-source software developed by the Massachusetts Institute of Technology (MIT), a handle server is provided at a center which manages, for each data item, the handle (identifier) of the data item and information of the server which manages the data item. Each DSpace platform resolves the server managing the actual data item corresponding to a handle provided by the user by inquiring the handle server of the handle.

The first and second related art techniques described above are limited to resolving locations of files and contents managed within one data management system, and cannot handle a situation, for example, in which the locations of the files and contents are moved within a plurality of data management systems on a network.

Although the DSpace system can handle these cases, because the DSpace system completely depends on the central management server, problems unique to centralized control systems occur; for example, data item on a server which is not registered in the central management server cannot be resolved, and when the central management server stops, the location of the data item cannot be resolved.

### SUMMARY OF THE INVENTION

According to one aspect of the present invention, there is provided a data management system in which a data server cooperates with other data servers connected via a network, wherein each data server includes a data management section in which one or more data items are stored; a request processor section that searches the data management section for data item requested from a client, provides the requested data item to the client when the requested data item is found, and transmits a data inquiry to other data server on the network to detect a data server storing the requested data item when the requested data item is not found; and a response section that searches, when receiving a data inquiry transmitted from another data server, the data management section for the requested data item and transmits to the another data server a result of the search.

According to another aspect of the present invention, there is provided a data management server including a data management section in which one or more data items are stored; a request processor section that searches the data management section for data item requested from a client, provides the requested data item to the client when the requested data item is found, and transmits a data inquiry to and receives a response from other data server on the network to detect a data server storing the requested data item when the requested data item is not found.

According to another aspect of the present invention, there is provided a data management method executed by a data server which forms a part of a data management system in cooperation with other data servers connected via a network, the method including: storing one or more data items; searching for data item requested from a client; when the requested data item is found, providing the requested data item to the client; and when the requested data item is not found, transmitting a data inquiry to other data server on the network to detect a data server storing the requested data item.

### BRIEF DESCRIPTION OF THE DRAWINGS

An embodiment of the present invention will be described in detail by reference to the drawings, wherein:

FIG. 1 is a diagram schematically showing the structure of a data management system according to an embodiment of the present invention;

FIG. 2 is a diagram showing the structure of management information of data in the data management section;

FIG. 3 is a diagram exemplifying a virtual URL;

FIG. 4 is a flowchart showing processing performed by a data server when receiving data request information from a client;

FIG. 5 is a flowchart showing processing performed by the data server when receiving an inquiry from another data server;

FIG. 6 is a diagram for explaining an operation of the system according to the embodiment of the present invention;

FIG. 7 is a diagram for explaining an operation of the system according to the embodiment of the present invention;

FIG. 8 is a diagram for explaining an operation of the system according to the embodiment of the present invention;

FIG. 9 is a diagram schematically showing a structure of a data server according to a first alternative embodiment;

FIG. 10 is a flowchart showing processing performed by the data server of the first alternative embodiment when receiving data request information from a client;

FIG. 11 is a flowchart showing processing performed by the data server of the first alternative embodiment when receiving an inquiry from another data server;

FIG. 12 is a diagram for explaining an operation of the system according to the first alternative embodiment of the present invention;

FIG. 13 is a diagram schematically showing a structure of a data server according to a second alternative embodiment of the present invention;

FIG. 14 is a diagram showing a data structure of location information which is stored in a location information cache;

FIG. 15 is a flowchart showing processing performed by the data server according to the second alternative embodiment of the present invention when receiving data request information from a client;

FIG. 16 is a flowchart showing processing performed by the data server according to the second alternative embodiment when the data server receives an inquiry from another data server;

FIG. 17 is a diagram for explaining an operation of the system according to the second alternative embodiment of the present invention;

FIG. 18 is a diagram exemplifying a virtual URL containing redirect origin information;

FIG. 19 is a diagram schematically showing the structure of a data server according to a third alternative embodiment of the present invention;

FIG. 20 is a diagram showing a data structure of a log record stored in a log storage section;

FIG. 21A is a flowchart showing a portion of processing performed when the data server according to the third alternative embodiment of the present invention receives data request information from a client;

FIG. 21B is a flowchart showing the remaining portion of the processing performed when the data server according to the third alternative embodiment of the present invention receives the data request information from the client;

FIG. 22 is a flowchart showing processing performed by the data server when the data server receives cache update information;

FIG. 23 is a diagram for explaining an operation of a system according to the third alternative embodiment of the present invention;

FIG. 24A is a diagram exemplifying a log record stored in each data server in FIG. 23;

FIG. 24B is a diagram exemplifying another log record stored in each data server in FIG. 23; and

FIG. 25 is a flowchart showing processing performed when cache update information is fed back in order to confirm that requested data are not present.

### DETAILED DESCRIPTION OF THE INVENTION

An embodiment of the present invention will now be described by reference to the drawings.

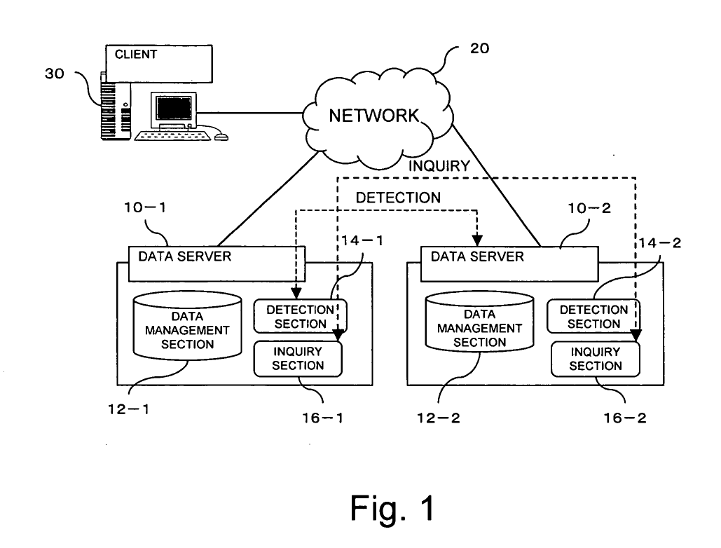

FIG. 1 is a diagram schematically showing the structure of a data management system according to an embodiment of the present invention. As shown in FIG. 1, the system includes multiple data servers 10-1, 10-2, . . . which are connected to a network 20 such as a LAN (Local Area Network) or the Internet (hereinafter, simply referred to as “data servers 10” unless the data servers must be distinguished; the same applies to modules within the data server 10). The system provides requested data in response to a data request from a client 30 on the network 20.

Each data server 10 includes a data management section 12, a detection section 14, and an inquiry section 16. In the data management section 12, one or more data items are stored and can be provided to the client 30 (hereinafter, data items may be referred to as simply “data”). The data management section 12 manages each of the stored data items in correspondence to a globally unique data ID (identifier). For example, the globally unique data ID may be an identifier of 128 bits known as UUID (Universally Unique IDentifier) or GUID (Globally Unique IDentifier). The UUID contains the time of creation of the UUID, a MAC (Media Access Control) address of a network card provided in a machine used for creation of the UUID, etc. for assuring global uniqueness. The URL uniquely indicates data using a host name of the data server 10 having the data item and the path name indicating the location at which the data item is actually stored in the data server 10 while the data ID of the present embodiment is an identifier independent from the information of the location of data.

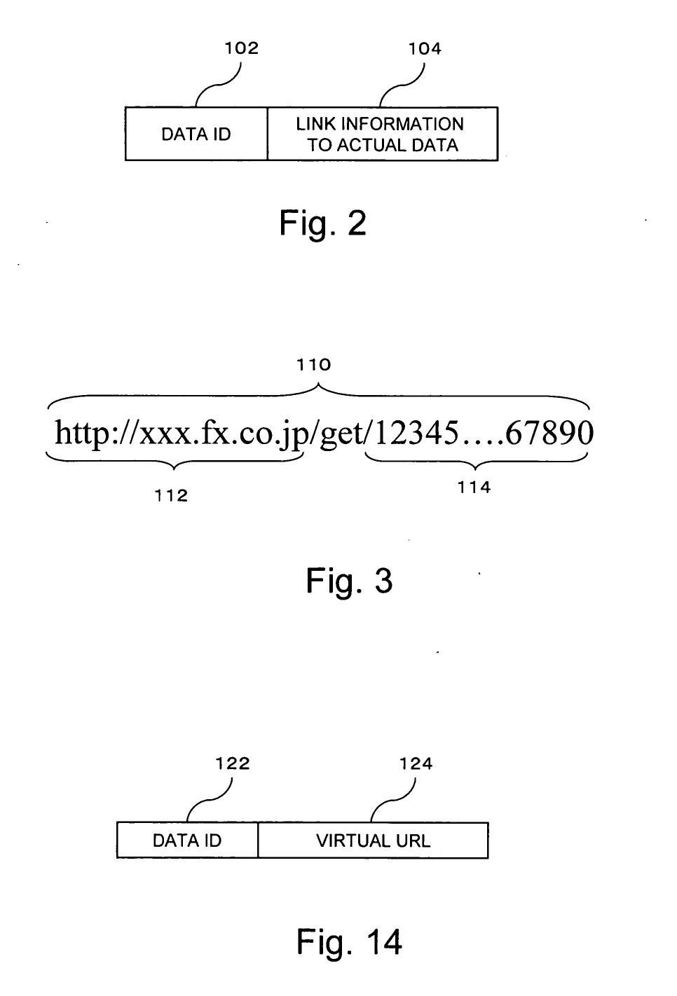

FIG. 2 shows a data structure of management information of each data item managed by the data management section 12. As shown in FIG. 2, the data management section 12 manages each stored data item by correlating a data ID 102 of the data and link information 104 (for example, the path name of the data) which indicates the data within the data server 10.

When a new data item is to be stored, the data management section 12 creates a globally unique data ID and manages the data by correlating the data ID with the link information indicating the stored location of the data. When a managed data item is deleted from the data server 10, the data management section 12 also deletes the management information of the deleted data item.

When a data item to which a data ID is already attached is to be stored in the data management section 12 (for example, when a data item managed by a data server is moved to another data server), the data management section 12 does not attach a new data ID to the data item and manages the data by correlating the link information of the data item with the data ID which is already attached.

The detection section 14 is a unit which detects another data server 10 present on the network 20.

The inquiry section 16 is a unit which transmits an inquiry to another data server 10 as whether or not the other data server 10 has the data item requested by the client 30. The inquiry section 16 also has a function of responding to an inquiry from an inquiry section 16 of another data server 10.

In the present embodiment, when the client 30 requests data item from the system, the client 30 designates the data item using a virtual URL 110 including a host name 112 of the data server 10 which manages the data item and the data ID 114 of the data item, as shown in FIG. 3. Because the virtual URL 110 is a URL, the virtual URL 110 contains information on protocol, port, etc., but these aspects are not described here. Because the number of digits of the globally unique data ID is much greater than the number of digits of the data ID 114 exemplified in FIG. 3, a portion of the data ID is omitted in FIG. 3. The virtual URL shown in FIG. 3 indicates data item managed by a data server called “xxx.fx.co.jp” and having a data ID of “12345 . . . 67890.” In the virtual URL of FIG. 3, the term “get” between the host name 112 and the data ID 114 indicates a name of a method provided by the data server 10. When the data server 10 allows the client 30 to perform multiple types of operations with respect to the data item managed by the data management section 10, the virtual URL is configured to contain the method indicating the operation. When, on the other hand, the data server 10 simply provides the requested data item to the client 30, such a description of method is not necessary.

When the client 30 (for example, a web browser) requests data item using the virtual URL 110, data request information containing the data ID 114 is transmitted to a server indicated by the host name 112.

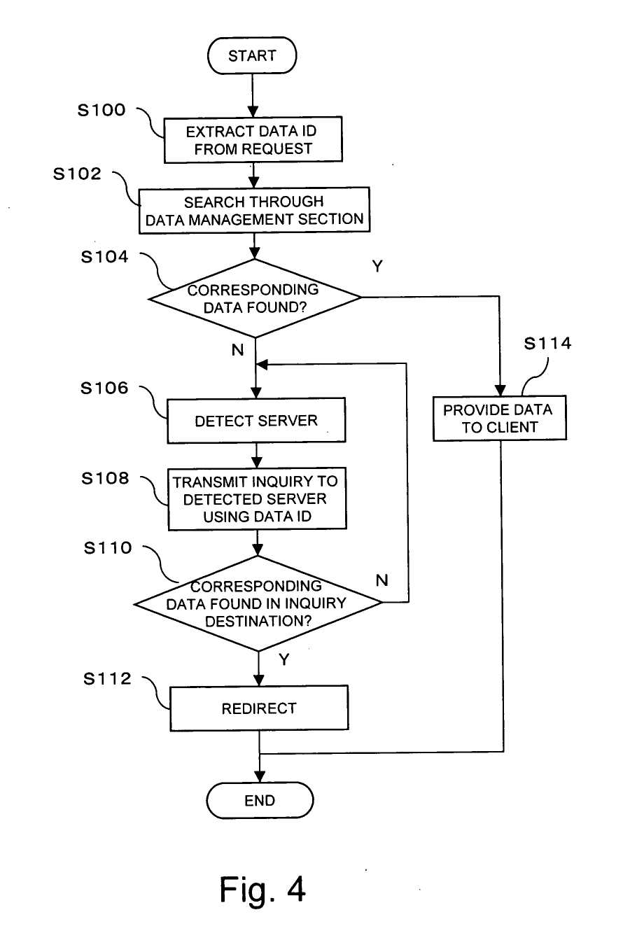

Next, processing performed when the data server 10 receives data request information from the client 30 will be explained by reference to FIG. 4. In the following description, for the sake of convenience the processing is explained as processing performed by the data server 10-1, but processing performed by the other data servers is similar to that described.

In this processing, the data server 10-1 extracts the data ID from the data request information from the client 30 (S100) and searches the data management section 12-1 for link information of the actual data item corresponding to the data ID (S102). When the link information corresponding to the data ID is found (when the determination result in step S104 is YES (Y)), the data server 10-1 obtains the actual data item indicated by the link information from the storage device within the data server 10-1 and provides the obtained data to the client 30 (S114).

When, on the other hand, the link information corresponding the data ID is not found (when the determination result in step S104 is NO (N)), the data server 10-1 instructs the detection section 14-1 to detect other data servers 10-2, etc. forming the present system, and in response to the instruction, the detection section 14-1 detects other data servers (S106). Detection of the other data servers 10-2, etc. by the detection section 14-1 can be achieved by, for example, the detection section 14-1 broadcasting to the network 20 a predetermined message for detecting other servers. The detection section 14 of each data server 10 has a protocol for recognizing the message for detecting other servers and responding to the message. In other words, the detection section 14-2 of another data server 10-2 receiving the message for detecting other servers transmits a response to the message containing a server ID (identifier) of the data server 10-2 according to the protocol. For example, an IP address or a host name may be used as the server ID. The detection section 14-1 which has transmitted the message for detecting other servers receives the response from the data server 10-2 and obtains the server ID contained in the response. In this manner, another data server 10-2 which is a part of the present system can be found.

When the other data server 10-2 is found, the data server 10-1 instructs the inquiry section 16-1 to transmit an inquiry to the found data server 10-2. In response to this instruction, the inquiry section 16-1 transmits to the data server 10-2 a data inquiry containing the data identifier contained in the data request from the client 30 and inquires as whether or not the data server 10-2 has the data item corresponding to the data identifier (S108). An operation performed by the inquiry section 16-2 of the data server 10-2 receiving this inquiry will be described later.

When the result of inquiry shows that the data server 10-2 to which the inquiry has been transmitted does not have the data item (when the determination result of step S110 is NO (N)), the data server 10-1 repeats detection of another data server (S106) and transmission of inquiry (S108). Steps S106 and S108 are repeated until a data server 10 having the data item is found.

Although FIG. 4 shows a procedure in which one data server is detected in step S106 and an inquiry is transmitted to the data server in step S108, the present invention is not limited to such a configuration, and it is also possible, for example, to detect all data servers 10 which can be detected through broadcasting in step S106, store the found data servers 10, and sequentially transmit the inquiry to each data server 10 in step S108.

When the result of inquiry shows that the data server 10-2 to which the inquiry has been transmitted has the data (when the determination result in step S110 is YES (Y)), the data server 10-1 returns to the client 30 redirect information containing the server ID of the data server 10-2 (S112). The return of the redirect information can be achieved, for example, according to a general redirect method of HTTP (HyperText Transfer Protocol). That is, the data server 10-1 returns to the client 30 redirect information containing a status code indicating redirect, such as 302 (found), and a location field containing the URL of the redirect destination. The URL of the redirect destination contained in the redirect information is the above-described virtual URL containing the server ID of the data server 10-2 which is the redirect destination and the data identifier of the requested data item. Because the server ID of the redirect destination is already known during the inquiry and the data identifier of the requested data item is also known, the data server 10-1 can create the virtual URL containing these pieces of information.

The client 30 receiving the redirect information transmits a data request containing the data identifier within the redirect information to the data server 10-2 indicated in the server ID according to HTTP.

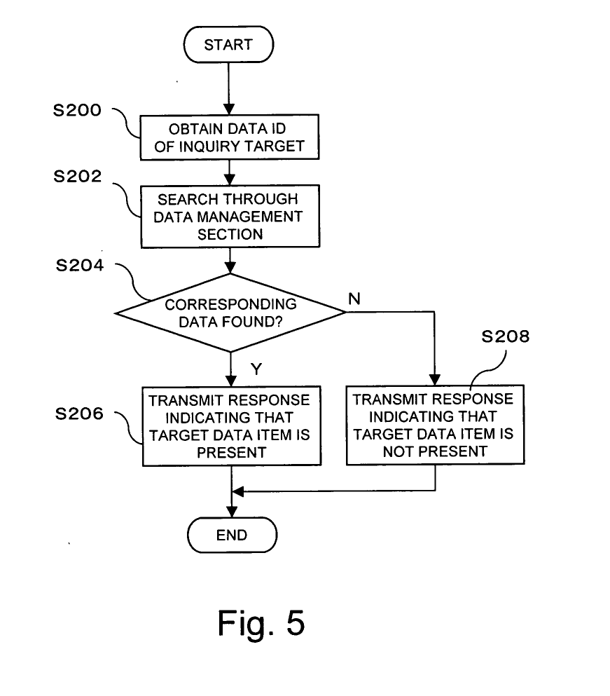

Next, processing performed by a data server when the data server receives an inquiry from another data server will be described by reference to FIG. 5. In the following description, for the sake of convenience the processing is described as processing performed by the data server 10-2, but the other data servers perform similar processing.

When the inquiry section 16 of the data server 10-2 receives a data inquiry from the inquiry section 16 of the data server 10-1, the inquiry section 16 extracts the data ID of the target data item from the information of the data inquiry (S200) and searches the data management section 12-2 for link information corresponding to the data ID (S202). When as a result of the search the link information corresponding to the data ID is found in the data management section 12-2 (when the determination result of step S204 is YES (Y)), the inquiry section 16-2 returns to the data server 10-1 which has transmitted the inquiry a message indicating that the data server 10-2 has the data item which is the target of the inquiry (S206). When, on the other hand, the link information is not found (when the determination result in step S204 is NO (N)), the inquiry section 16-2 returns to the data server 10-1 a message indicating that the data server 10-2 does not have the data item which is the inquiry target (S208).

Alternatively, in step S206, instead of returning to the inquiry origin a message that the data item which is the inquiry target is present, it is also possible to return the virtual URL of the data item which is the inquiry target (that is, the virtual URL containing the server ID of the data server 10-2 having the data and the data identifier of the data). In this configuration, in step S112 the data server 10-1 which has transmitted the inquiry may return to the client 30 the virtual URL provided by the data server 10-2.

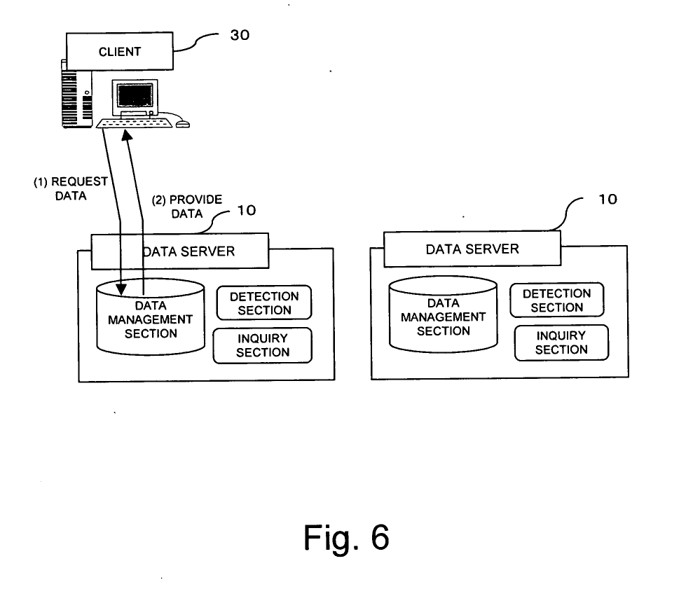

An operation of the data management system as described above will now be described referring to FIGS. 6-8.

As shown in FIG. 6, when the data server 10-1 has the target data of the data request (1) transmitted from the client 30 to the data server 10-1, the target data item is provided from the data server 10-1 to the client 30 (2).

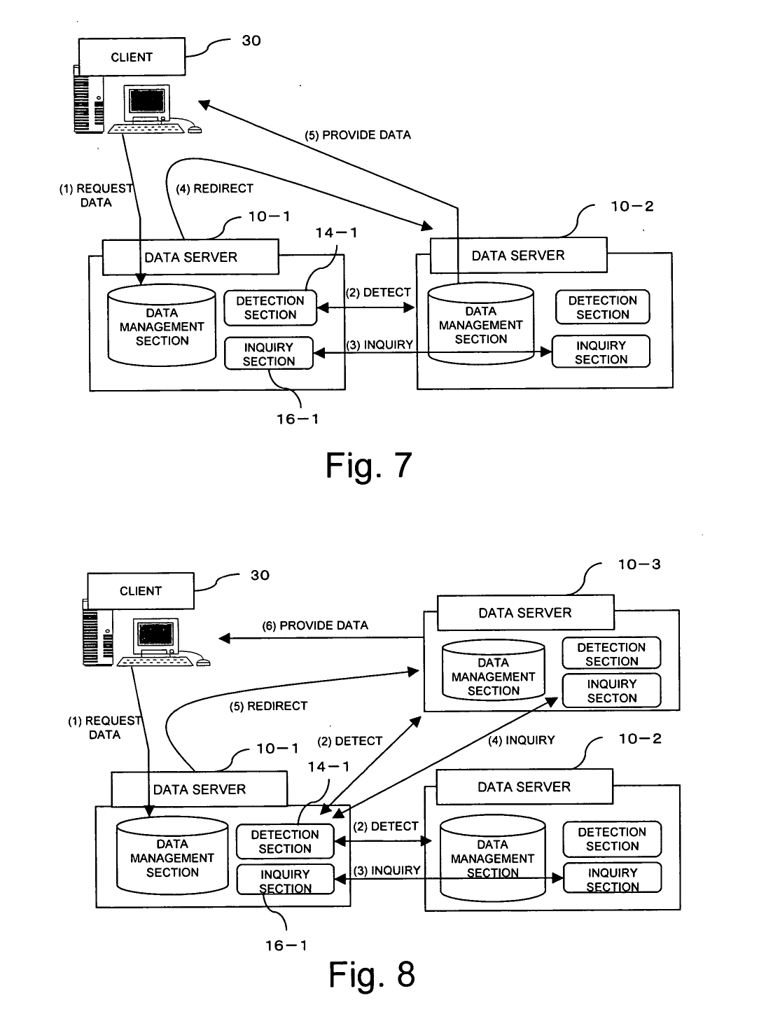

When, on the other hand, the target data item of the data request (1) transmitted from the client 30 to the data server 10-1 is not present in the data server 10-1 as shown in FIG. 7, the detection section 14-1 detects another data server 10-2 (2) and transmits a data inquiry to the data server 10-2 (3). When the result of inquiry shows that the data server 10-2 has the requested data item, the data server 10-1 redirects the data request from the client 30 to the data server 10-2 (4). In response to the redirected data request, the data server 10-2 provides the requested data item to the client 30 (5).

FIG. 8 shows a situation in which the data item requested by the client 30 is present in neither the data server 10-1 nor the data server 10-2, but is present in a data server 10-3. In this case (2), of the data servers 10-2 and 10-3 detected by the detection section 14-1, the inquiry section 16-1 first transmits an inquiry to the server 10-2 and receives a response that the data server 10-2 does not have the data item (3). Then, the inquiry section 16-1 transmits the inquiry to the next data server 10-3 and receives a response that the data server 10-3 has the data item (4). The data server 10-1 redirects the data request from the client 30 to the data server 10-3 (5). In response to the redirected data request, the data server 10-3 provides the requested data to the client 30 (6).

As described, in the present embodiment, each data server 10 searches for a data server 10 having the data requested from the client 30 and redirects the request to the found data server 10. Therefore, because the requested data can be found even when no central management server is provided, a problem that the data cannot be resolved due to failure of a server can be significantly inhibited as compared with the related art.

In the present embodiment, even when the location of the data item changes because the data item is moved between data servers 10, the client 30 can access the data item using the virtual URL which is already present, so that the data server 10 which originally managed the data item; that is, the data server 10 corresponding to the server ID within the virtual URL, receives the access request and searches for a data server 10 which currently has the data. Therefore, the client 30 can obtain the data item using the virtual URL which the client 30 already has.

Some known data servers have a function of, for example, distributing to the user through an electrical mail a URL which can check a change when the data on the server change, such as when a data item is newly stored. When, however, the data item on the server is moved to another server, the distributed URL becomes unusable. When the mechanism of the present embodiment is employed, however, even in such a situation the client can obtain the data item using the virtual URL distributed before the data movement. In addition, commonly, a data server 10 must be divided because of an increase in the amount of data to be managed. In such a situation also, according to the present embodiment, the virtual URL distributed among the users before the division can be used after the division.

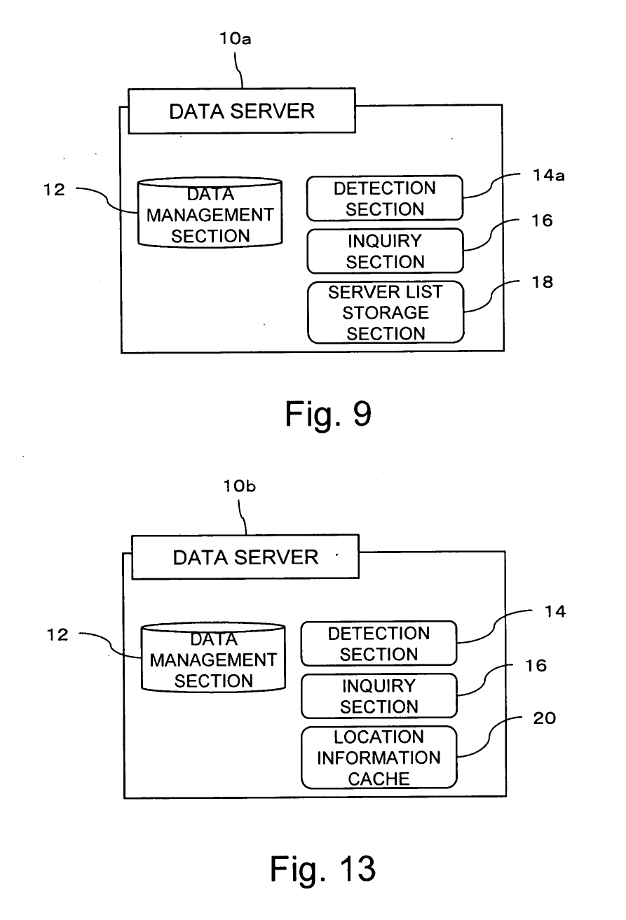

A first alternative embodiment of the embodiment will now be described. In the above-described embodiment, the detection section 14 detects other data servers 10 by broadcasting a predetermined message. In the first alternative embodiment, as shown in FIG. 9, each data server 10a forming a part of the data management system has a server list storage section 18 which stores a list of server IDs for other data servers 10a (hereinafter referred to as “server list”). The server list may be stored in the server list storage section 18 by the administrator of the data server 10a or may be automatically created on the basis of a detection result through the detection method by broadcasting as described above. It is also possible to add to the server list storage section 18 information of a server list obtained from another data server 10a during processes to be described below. A detection section 14a detects another data server 10a using the server list storage section 18.

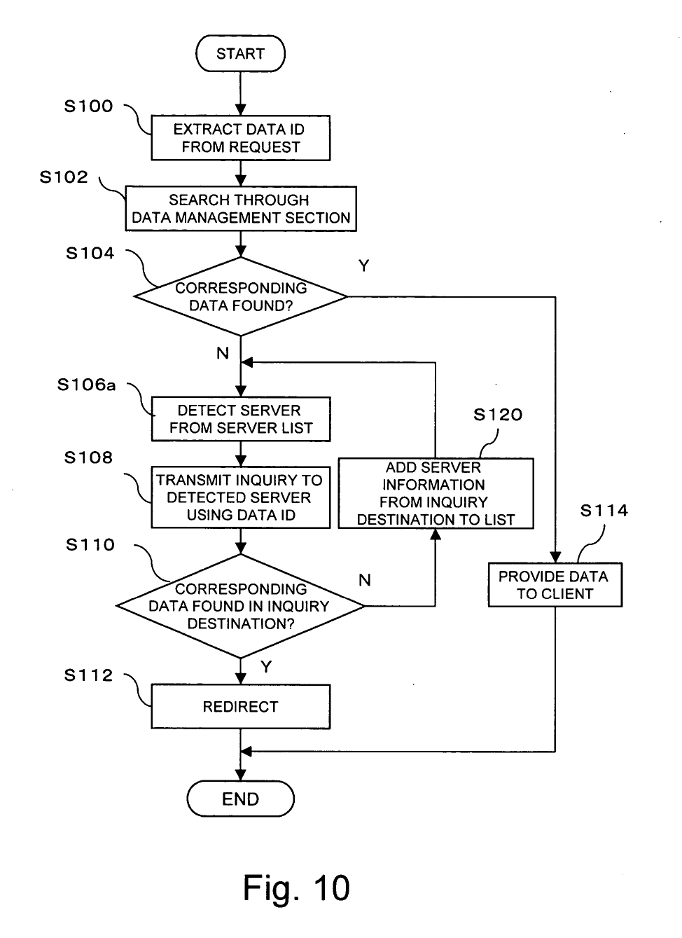

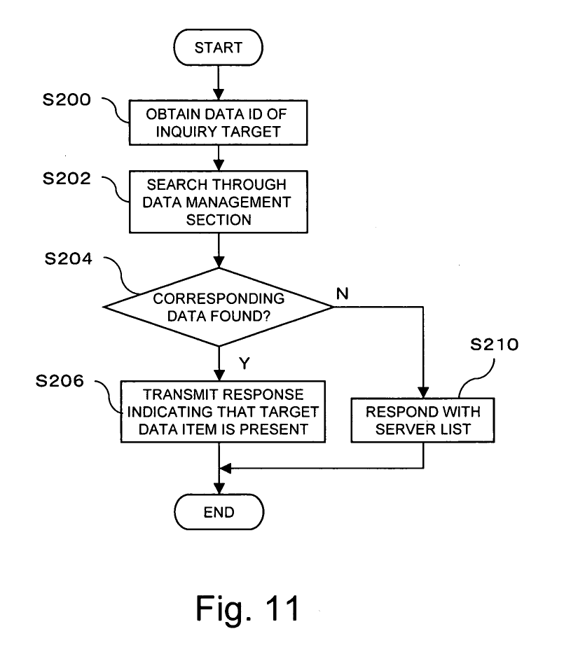

FIG. 10 shows processing performed by the data server 10a of the first alternative embodiment when the data server 10a receives a data request from a client 30. FIG. 11 shows processing performed when the data server 10a of the first alternative embodiment receives a data inquiry from another server. In these procedures, steps identical to the steps in FIGS. 4 and 5 are assigned the same reference numerals and their repeated descriptions are omitted.

In the processing illustrated in FIG. 10, when the data server 10a does not have the data item requested by the client 30, the detection section 14a detects, from the server list storage section 18, an identifier of a server to which an inquiry has not been transmitted (S106a) and the data server 10a transmits an inquiry as whether or not the detected server has the requested data item(S108).

As shown in FIG. 11, when a data server 10a receiving the inquiry cannot find the data ID of the requested data item in the data management section 12 of the data server 10a, the data server 10a returns to the data server 10a which has transmitted the inquiry all or a portion of the server list stored in the server list storage section 18 (this may be, for example, one server ID) (S210).

Returning to the processing illustrated in FIG. 10, similar to the above-described embodiment, the data server 10a receiving the response from the inquiry destination redirects the request from the client 30 to the inquiry destination when the response indicates that the inquiry destination has the requested data item (S112). When, on the other hand, the response indicates that the inquiry destination does not have the requested data item, the data server 10a adds to the server list storage section 18 the information of the server list received from the inquiry destination (S120), and processing returns to step S106a.

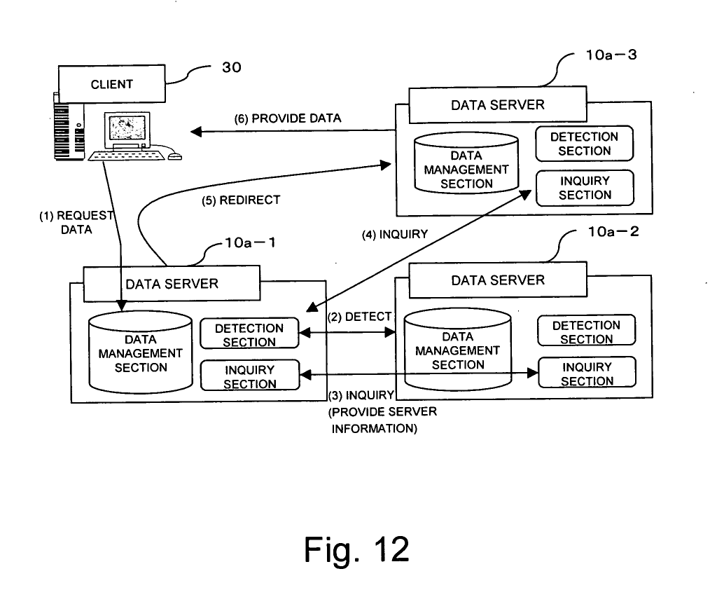

An operation of the system according to the first alternative embodiment of the present invention will now be described by reference to FIG. 12. In FIG. 12, for the sake of simplicity some of the sections in the data server 10a are omitted. FIG. 12 shows an example situation in which a server 10a-2 is registered in the server list storage section 18 (not shown) of a data server 10a-1, but a server 10a-3 is not registered.

When the target data item of a data request (1) transmitted from the client 30 to the data server 10a-i is not present in the data server 10a-1, the detection section 14a detects the data server 10a-2 using the server list storage section 18 (2) and transmits a data inquiry to the data server 10a-2 (3). When the data server 10a-2 transmits a response to the inquiry that the data server 10a-2 does not have the data item, the inquiry section 16 transmits an inquiry to the next data server, 10a-3, and obtains a response that the data server 10a-3 has the data item (4). The data server 10a-1 redirects the data request from the client 30 to the data server 10a-3 (5). In response to the redirected data request, the data server 10a-3 provides the requested data item to the client 30 (6).

According to the first alternative embodiment, the data server 10a can be informed of data servers 10a which are not registered in the server list storage section 18, by obtaining a server list of another data server 10a, and, therefore, the data server 10a can transmit an inquiry to the newly known data server 10a.

Alternatively, it is also possible to combine the method of detecting the other data servers in the first alternative embodiment with a detection method by broadcasting as described with reference to the embodiment. For example, in the example configuration of FIG. 12, there may be employed a configuration in which the data server 10a-1 initially does not have the server list, detects a data server 10a-2 by broadcasting, and obtains information of the server list from the server 10a-2. In this case, the server 10a-1 can store the server ID detected through the broadcasting and the server list obtained from the server 10a-2 by the server list management section 18 and detect the servers through the processing shown in FIG. 11 with respect to the subsequent data requests. The server 10a-1 may also be configured to not store the detected server ID or the like.

Alternatively, there may also be employed a configuration in which the data server 10a-1 detects other servers through broadcasting when no more data servers are contained in the server list storage section 18 to which the inquiry has not been transmitted in the processing of FIG. 11, and registers the result of the detection in the server list storage section 18.

Next, a second alternative embodiment will be described by reference to FIGS. 13-17. In the second alternative embodiment, as shown in FIG. 13, a data server 10b has a location information cache 20 which caches the location information of data that is determined through inquiry by the inquiry section 16. As shown in FIG. 14, a location information record which is cached to the location information cache 20 contains a data ID 122 and a virtual URL 124 (similar to the virtual URL shown in FIG. 3) which indicates the location of the data item indicated by the data ID 122. Alternatively, the location information record may contain, instead of the virtual URL 124, a server ID of the data server 10b which manages the data.

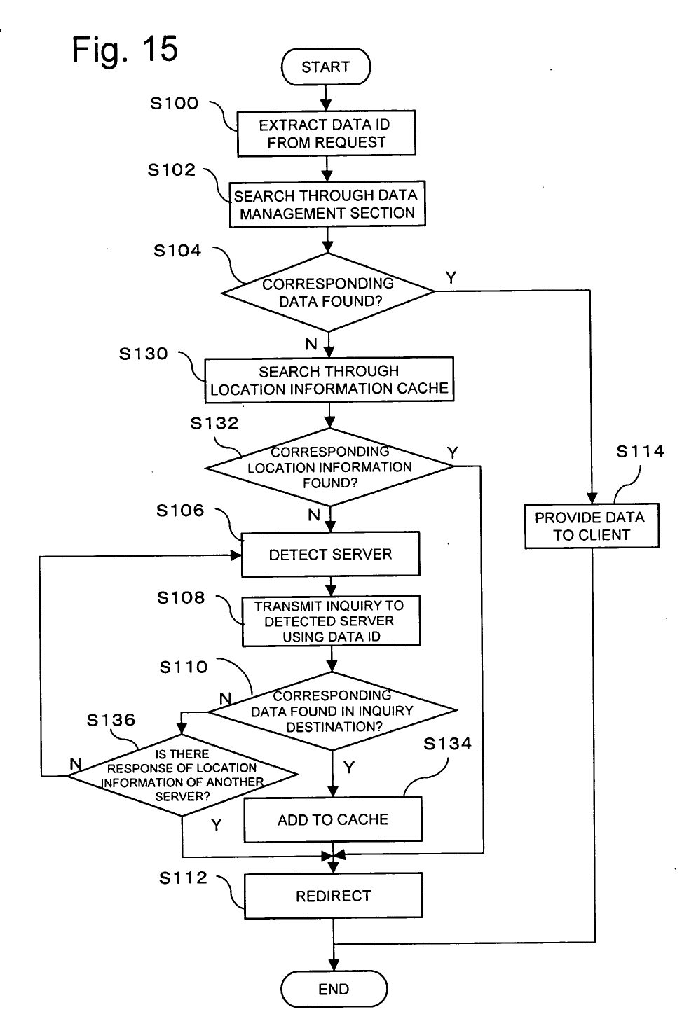

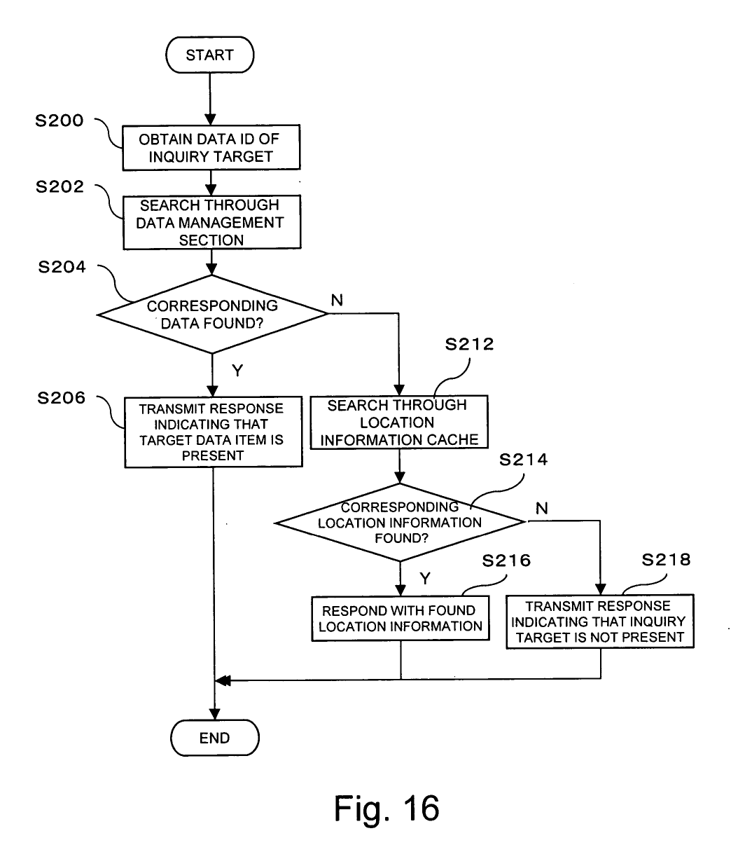

FIG. 15 shows processing performed by the data server 10b according to the second alternative embodiment of the present invention when the data server 10b receives data request information from a client. FIG. 16 shows processing performed when the data server 10b of the second alternative embedment receives a data inquiry from another server. In these procedures, steps identical with those shown in FIGS. 4 and 5 are assigned the same reference numerals, and their repeated descriptions are omitted.

In the processing shown in FIG. 15, when the data server 10b does not have a data item requested by the client 30, the data server 10b searches the location information cache 20 for the location information record corresponding to the data ID of the requested data item (S130). When the location information record is found (when the determination result in step S132 is YES (Y)), the virtual URL contained in the location information record is returned to the client 30 to redirect the data request by the client 30 (S112).

On the other hand, when the determination result in step S132 is NO (N), the data server 10b instructs the detection section 12 to detect another data server 10b (S106) and transmits, to the data server 10b thus detected, a data inquiry containing the data ID of the requested data item (S108).

As shown in FIG. 16, when the data server 10b receiving the inquiry cannot find the data ID of the requested data item in the data management section 12, the data server 10b searches the location information cache 20 for the location information record corresponding to the data ID (S212). When the location information record is found (when the determination result in step S214 is YES (Y)), the data server 10b returns to the data server 10b which has transmitted the inquiry the virtual URL (or server ID) in the location information record as information of a candidate of location of the requested data (S216). In some cases, the location found in the cache 20 may fail to accurately indicate the current situation because of elapse of time, and, thus, the location is handled not as the confirmed location information of the data, but as a candidate of the location information of the data. When, on the other hand, the location information cannot be found, the data server 10b transmits a response to the data server 10b which has transmitted the inquiry indicating that the data item which is the inquiry target is not present (S218).

Referring back to the procedure of FIG. 15, after the data server 10b receives a response from the inquiry destination, when the response indicates that the requested data item is present (or when the response is a virtual URL containing the server ID of the inquiry) (S110), in view that the requested data item is certainly present in the inquiry destination, the data server 10b receiving the response adds to the location information cache 20 the data identifier of the data item and a virtual URL containing the server ID of the inquiry destination (or, alternatively, the data identifier and the server ID) (S134) and, similar to the case of the above-described embodiment, redirects the request from the client 30 to the inquiry destination (S112). The order of steps S134 and S112 may be reversed. When the response from the inquiry destination is not information indicating that the requested data item is present, the data server 10b determines whether or not the response contains a virtual URL (or server ID) of the requested data item (S136).

When the determination of step S136 shows that the virtual URL (server ID) is contained (when the determination result in step S136 is YES (Y)), the data server 10b returns the virtual URL (or server ID) to the client 30 to redirect the data request (S112). On the other hand, when the determination result in step S136 is NO (N), on the other hand, processing returns to step S106.

In the procedure shown in FIG. 15, when the response from the inquiry destination is a candidate of the location information (when the determination result in step S136 is Y), the location information is not added to the cache 20 and only redirection is performed. This is because the location information stored in the cache 20 of each server 10b may fail to accurately indicate the current situation due to elapse of time. In other words, in the procedure of FIG. 15, the location information is registered in the cache 20 only when the inquiry destination is confirmed to have the requested data item. This method, however, is merely an example, and, alternatively, it is also possible to employ a configuration in which all location information received from the inquiry destination is registered in the location information cache 20 regardless of whether the location information is held in the inquiry destination or in another server.

In the second alternative embodiment, when redirection is performed using the location information determined from the location information cache 20 (which includes location information determined from the cache 20 of the inquiry destination) (S112), there maybe cases in which the requested data item is not present in the data server 10b which is the redirect destination, because of a reason such that the information of the cache 20 is old. In such a situation, the data server 10b which is the redirect destination searches, according to the processing shown in FIG. 15, for a data server which has the data item and redirects the data request to the found data server. With repetition of the redirect process, the client 30 can obtain the requested data item.

In the processing shown in FIG. 15, broadcasting is used for detecting the other data servers, but the present invention is not limited to such a configuration, and a method similar to the first alternative embodiment using the server list may alternatively be used.

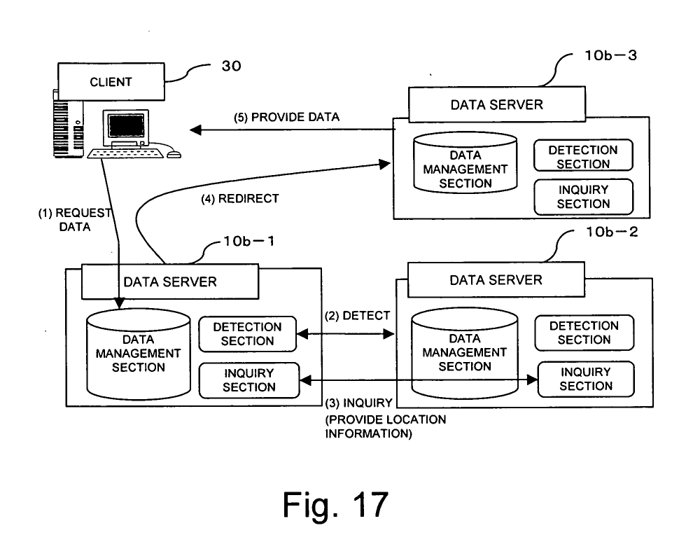

An operation of the system of the second alternative embodiment will now be described by reference to FIG. 17. In FIG. 17, for the sake of simplicity, some of the sections in the data server 10b are omitted.

When the target of the data request (1) transmitted from the client 30 to the data server 10b-1 is not present in the data server 10b-1, the detection section 14 detects another data server 10b-2 (2) and a data inquiry is transmitted to the data server 10b-2 (3). When the data server 10b-2 does not have the data item, but has location information in the cache 20 indicating that the data server 10b-3 has the data item, the data server 10b-2 returns the location information to the server 10b-1. The data server 10b-1 receiving the location information transmits the location information to the client 30 to redirect the data request to the data server 10b-3 (4). The data server 10b-3 provides the requested data item to the client 30 when the data server 10b-3 has the target data item of the redirected data request (5).

As described, according to the second alternative embodiment, when the data server 10b caches location information of the target data of the request from the client 30 or the inquiry from another server 10b, the data item can be effectively provided to the client 30 by reporting the location information to the request origin and the inquiry origin.

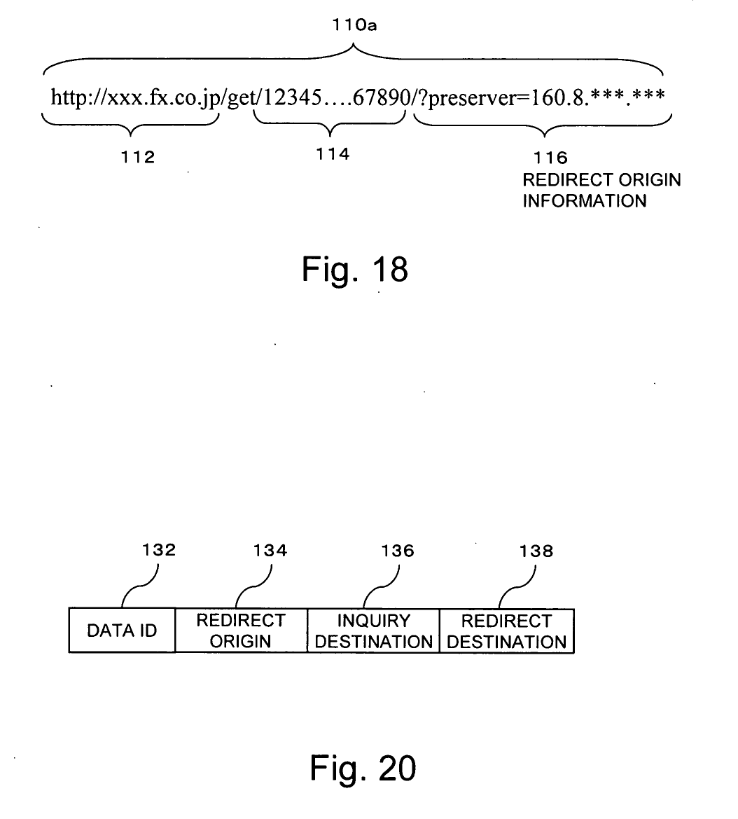

In the second alternative embodiment, when the data in the location information cache 20 is old, the data request would be redirected to an erroneous server 10b. A third alternative embodiment for resolving such a problem will now be described by reference to FIGS. 18-25.

A basic concept of the third alternative embodiment is that, when a location of the requested data item (that is, the data server managing the data item) is confirmed, this confirmation is reported to the data servers which have played a role in the process until the location of the data is confirmed, to thereby update the location information caches 20 of these servers.

In order to realize such a method, in the third alternative embodiment, a mechanism is introduced to notify the data server which is the redirect destination of the data server of the redirect origin. Specifically, the server ID of the data server which is the redirect origin is incorporated in the redirect information to be returned to the client 30 by the data server which is the redirect origin; that is, the virtual URL. For example, the virtual URL 110a shown in FIG. 18 contains, at an end of the virtual URL containing an identifier of the server which is the redirect destination (host name 112) and a data ID 114, an HTTP query text string indicating the identifier of the server of the redirect origin as redirect origin information 116. This is a text string that shows the identifier of the server which is the redirect origin, as an IP address (“160.8.***.***”). The description of the server ID is not limited to the IP address, and the server ID may alternatively be described by other methods such as, for example, a host name. In this manner, by transferring the virtual URL to the server of the redirect destination while incorporating the redirect origin information 116 in the virtual URL, the server which is the redirect destination can feed back the location information to the server which is the redirect origin when the location of the requested data is confirmed.

In the third alternative embodiment, each data server records, until the location of the requested data is confirmed, the data server which is the inquiry destination to which the data inquiry is transmitted and notifies each inquiry destination of the confirmed location information.

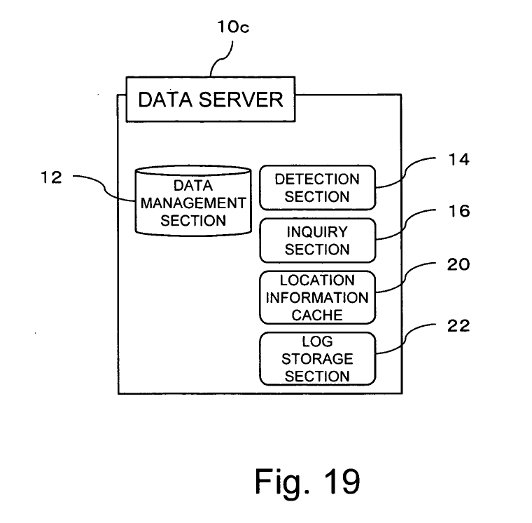

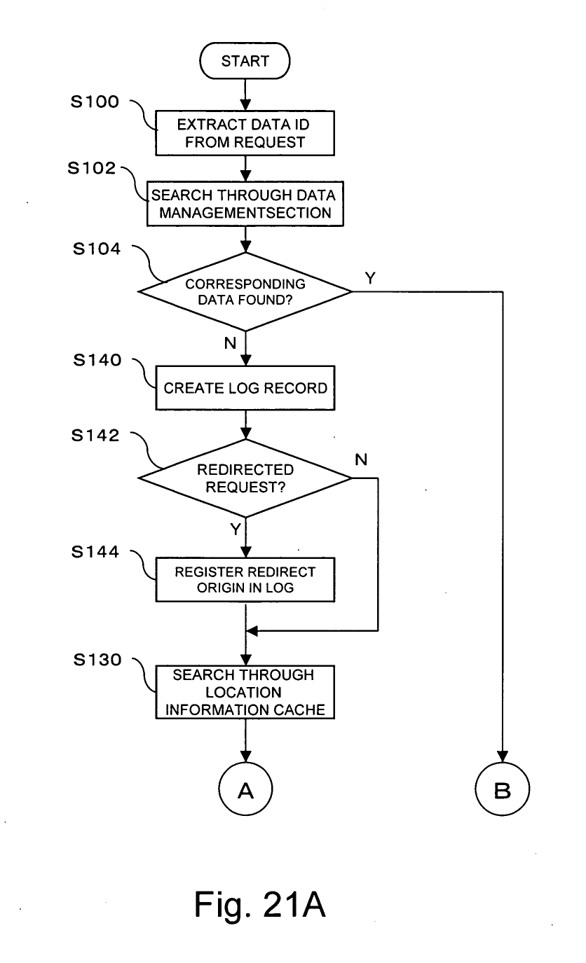

In the third alternative embodiment, as shown in FIG. 19, each data server 10c has a log storage section 22 in addition to the location information cache 20. The log storage section 22 stores a log which records redirect from another data server 10c, a data inquiry to another data server, and the details of the redirection. The log storage section 22 records one log record with respect to a data request received from the client 30. FIG. 20 exemplifies a data structure of the log record. In this example structure, the log record contains a data ID 132 of the requested data of the data request, a server ID 134 of a redirect origin server of the data request, a server ID 136 of the inquiry destination to which a data inquiry is transmitted in response to the data request, and a server ID 138 of a redirect destination to which the data request is redirected. Each log record has one data ID 132, one redirect origin 134, and one redirect destination 138. The number of inquiry destinations 136 is an integer which is 0 or greater, as there may be a case in which the redirect destination 138 is found in the location information cache 20 of the data server 10c (and thus, inquiry is not necessary) and cases in which the inquiry must be transmitted to multiple inquiry destinations before the redirect destination 138 is found.

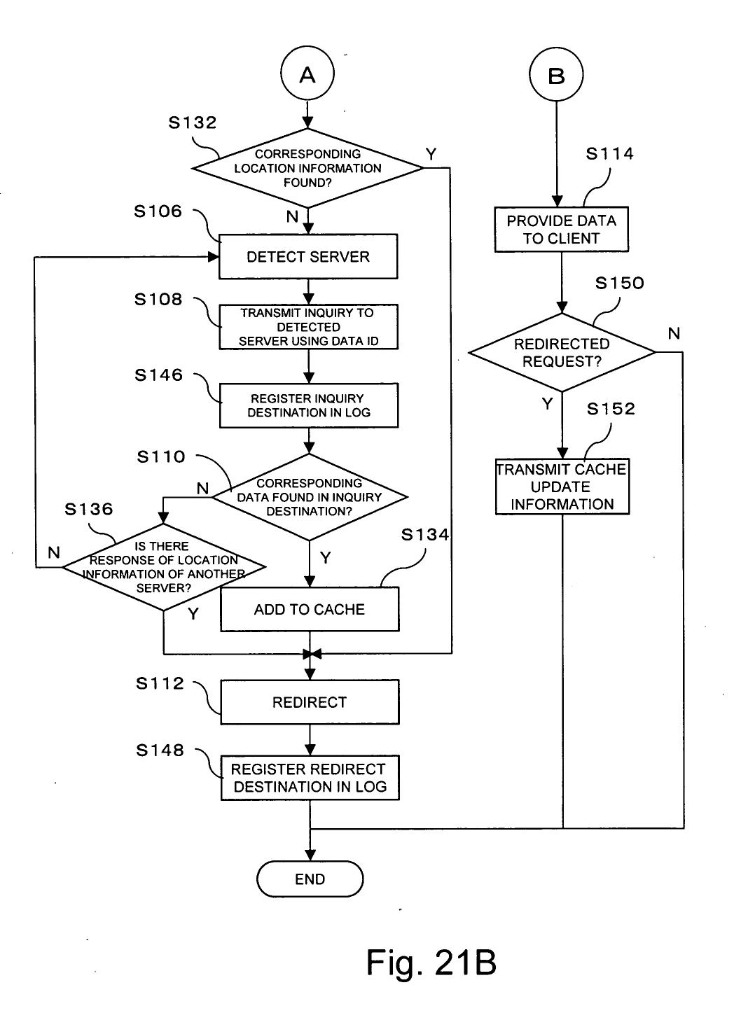

FIGS. 21A and 21B show processing performed when the data server 10c of the third alternative embodiment of the present invention receives data request information from a client. In this processing, steps identical with those in FIGS. 4 and 15 are assigned the same reference numerals and their repeated descriptions are omitted.

In the processing, when the requested data of the data request from the client 30 are not found in the data management section 12, the data server 10c creates in the log storage section 22 a log record regarding the requested data (S140). At this point, only the data ID 132 of the requested data item is registered in the log record (refer to FIG. 20). Then, a determination is made as to whether or not the data request contains redirect origin information (S142). When the data request contains redirect origin information, the redirect origin information is registered in the column of the redirect origin 134 in the log record (S144) When, on the other hand, the data request does not contain the redirect origin information, step S144 is skipped.

The data server 10c searches the cache 20 for location information of the requested data item (S130). When the location information is found in this search (YES in S132), the data server 10c notifies the client 30 of the location information to redirect the data request (S112). During this processing, the server ID of the redirect destination indicated in the location information is registered in the column of the redirect destination 138 of the log record (S148).

When the location information of the requested data is not found in the cache 20 (NO in S132), the detection section 14 detects another data server (S106) and the inquiry section 16 transmits to the detected data server a data inquiry containing a data identifier of the requested data item (S108). When the data server 10c transmits a data inquiry to another data server, the data server 10c adds the server ID of the transmission destination of the inquiry in a column of the inquiry destination 136 of the log record corresponding to the data identifier (S146). When the data server 10c receives a response indicating that the inquiry destination has the requested data item (YES in S110), the data server 10c adds, to the cache, the location information indicating that the inquiry destination server has the requested data item (S134) and redirects the request from the client 30 to the inquiry destination (S112). The data server 10c registers the server ID of the redirect destination (in this case, the redirect destination is identical with the inquiry destination) to the log record of the requested data item (S148).

When the determination result in step S110 is NO (N), a determination is made as to whether or not the response from the inquiry destination contains the location information of the requested data item (S136). When this determination shows that the response contains the location information, the data server 10c returns the location information to the client 30 to redirect the data request (S112) and registers the server ID contained in the location information to the column of the redirect destination 138 of the log record corresponding to the requested data item (S148). When, on the other hand, the determination result in step S136 is NO (N), processing returns to step S106.

When in step S104 the data server 10c finds the requested data item in the data management section 12, the data server 10c provides the found data item to the client 30 (S114). Then, the data server 10c determines whether or not the data request from the client 30 contains the redirect origin information (S150). When the data request contains the redirect origin information, the data server 10c creates cache update information indicating that the requested data item is present in the data server 10c and transmits the information to the data server indicated in the redirect origin information (S152). The cache update information may contain the data ID of the requested data item and the identifier of the data server 10c.

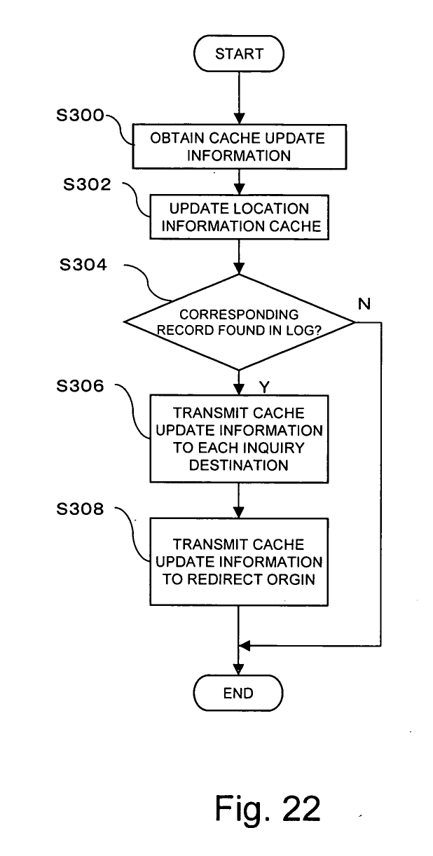

Next, processing performed by the data server 10c receiving the cache update information will be explained by reference to FIG. 22.

In this processing, when the data server 10c receives cache update information from another server (S300), the data server 10c updates the location information cache 20 using the information (S302). In the cache update process, for example, the location information corresponding to the data ID contained in the cache update information is searched in the cache 20, and, when such location information is not present, the data ID and the server ID contained in the cache update information is registered in the cache 20 as the location information. When the location information corresponding to the data ID in the cache update information is found in the cache 20, the location information is deleted from the cache and the location information created from the cache update information is added to the cache 20. The data server 10c searches the log storage section 22 for a log record corresponding to the data ID (S304). When such a log record is found, the data server 10c transmits similar cache update information to the data servers indicated in the inquiry destination 136 and the redirect origin 134 within the log record (S306 and S308). There may be cases in which one of the columns of the inquiry destination 136 and the redirect origin 134 is empty. Alternatively, there may be cases in which a plurality of servers are registered in the column of the inquiry destination 136. In such cases, the cache update information is transmitted to all inquiry destination servers.

When the data server 10c may receive the cache update information from either of the redirect destination and the inquiry origin, the procedure of FIG. 22 corresponds to either case.

The processing performed when the data server 10c of the third alternative embodiment receives a data inquiry from another server may be identical with that in the second alternative embodiment (refer to FIG. 16).

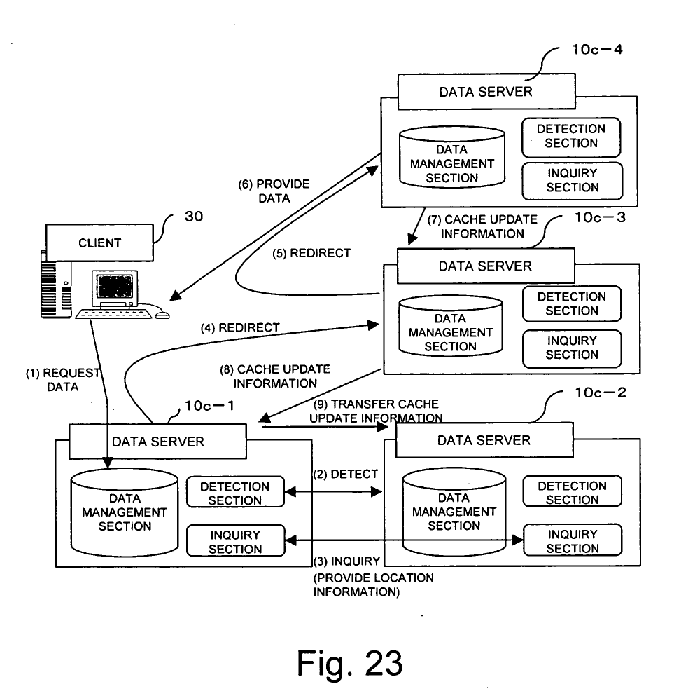

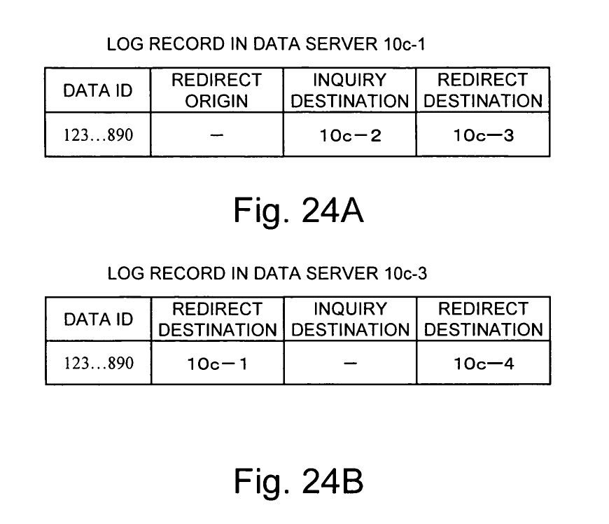

A specific example of an operation of the system of the third alternative embodiment will now be described by reference to FIGS. 23 and 24. In FIG. 23, for the sake of simplicity, some of the sections in the data server 10c are omitted.

When target data item of a data request transmitted from a client 30 to a data server 10c-1 (1) are not present in the data server 10c-1, the detection section 14 detects another data server 10c-2 (2) and a data inquiry is transmitted to the data server 10c-2 (3). Although the data server 10c-2 does not have the data item, because the data server 10c-2 has, in the cache 20, the location information indicating that the data server 10c-3 has the data item, the data server 10c-2 returns the location information to the server 10c-1. The data server 10c-1 receiving the location information transmits the location information to the client 30 to redirect the data request to the data server 10c-3 (4). The log record recorded in the data server 10c-1 in this sequence of operation is shown in FIG. 24A. In other words, the log record in this situation does not have the redirect origin 134, has the server 10c-2 in the inquiry destination 136, and has the server 10c-3 in the redirect destination 138.

In the illustrated configuration, the data server 10c-3 receiving the redirected data request from the client 30 does not have the requested data, but has, in the cache 20, the location information indicating that the data server 10c-4 has the data item. Therefore, the data server 10c-3 uses the location information and redirects the data request to the data server 10c-4 (5). The log record recorded in the data server 10c-3 in this sequence of operation is shown in FIG. 24B. In other words, the log record in this situation has the server 10c-1 in the redirect origin 134, does not have the inquiry destination 136, and has the server 10c-4 in the redirect destination 138.

Because the data server 10c-4 has the target data item of the redirected data request, the data server 10c-4 provides the data item to the client 30 (6). The data server 10c-4 creates cache update information and transmits the information to the data server 10c-3, which is the redirect origin (7).

The data server 10c-3 receiving the cache update information updates the data of the location information cache 20 using the cache update information (in this case, however, the location information within the cache 20 of the data server 10c-3 is accurate, and, thus, the location is not changed). The data server 10c-3 transfers the cache update information to the data server 10c-1, which is the redirect origin shown in the log record (refer to FIG. 24B) (8).

The data server 10c-1 receiving the cache update information updates its cache 20 on the basis of the update information. In this case, because the data server 10c-1 does not have in its cache 20 the location information regarding the requested data, the location information contained in the update information is added to the cache 20. The data server 10c-1 transfers the cache update information to the data server 10c-2, which is the inquiry destination shown in the log record (refer to FIG. 24A) (9).

The data server 10c-2 receiving the cache update information updates its cache 20 on the basis of the update information. In this case, because the data server 10c-2 has, in the cache 20, the location information indicating that the data server 10c-3 has the requested data, the location information is replaced with the location information contained in the update information.

As described, in the third alternative embodiment, the data server 10c determines that the location of the requested data item is confirmed when the data server 10c finds the requested data from its data management section 12, and feedback of the cache update information is started. The present invention, however, is not limited to such a configuration, and there may be employed a configuration in which, when the data server 10c transmits an inquiry to another data server and receives a response from the inquiry destination indicating that the inquiry destination has the requested data item, the inquiry origin creates cache update information and feeds back the cache update information to the redirect origin and other inquiry destinations. In this case, the information of redirect origin is not contained in the redirect information (virtual URL) returned from the inquiry origin to the client 30, because it is confirmed that the redirect destination has the data item requested by the inquiry, and feedback from the redirect destination is not necessary.

In addition to the above-described configuration in which the cache update information is fed back when the location of the requested data is confirmed, there may also be employed a configuration in which the data server 10c receiving the redirected data request feeds back cache update information to the redirect origin indicating that the data server 10c does not have the requested data when the data server 10c confirms that the data server 10c does not have the requested data item in its data management section 12.

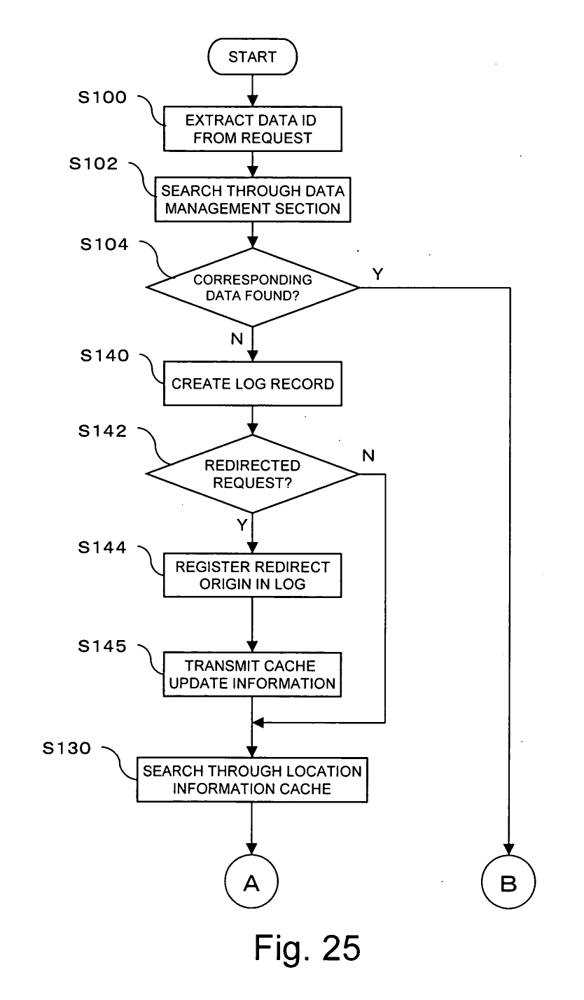

Processing performed in this configuration is shown in FIG. 25. The processing shown in FIG. 25 is a part of the sequence of the processing corresponding to the processing of FIG. 21A, and the subsequent processes are identical with those shown in FIG. 21B. Steps identical with those in the processing of FIG. 21A are assigned the same reference numerals, and their repeated descriptions are omitted.

In this processing, when the data server 10c determines that the requested data are not present in the data management section 12 (S104), the data server 10c determines whether or not a request from the client 30 is a redirected request (S142). When the request is a redirected request, the data server 10c creates cache update information indicating that the data server 10c does not have the requested data and feeds back the cache update information to the redirect origin (S144 and S145). The cache update information in this case is, for example, data containing a data ID, a server ID, and a flag indicating that the data item is not present. When the data server receiving the cache update information finds, in its location information cache 20, location information having a combination of the data ID and the server ID which is identical with that shown in the cache update information, the data server deletes the location information from the location information cache 20 and reversely transmits the cache update information to the inquiry destination and the redirect origin indicated in the log record.

In this manner, according to the third alternative embodiment, because the contents of the location information caches 20 of a group of data servers 10c can be updated to the most recent state, erroneous redirection operations can be reduced in number.

Although a configuration is described in the third alternative embodiment in which the cache update information is fed back to both the redirect origin and the inquiry destination, the present invention is not limited to such a configuration, and a certain degree of the advantage can be achieved by feeding back the cache update information to only one of the redirect origin and the inquiry destination.

The embodiment and the alternative embodiments described above can be applied not only to a situation in which the data item is moved between servers, but also to a situation in which the data item is moved within a single server and the URL is changed. For example, when the virtual URL of the data is “http://xxx.fx.co.jp/Folder1/Folder2/uuid1”, the term “uuid1” is the data ID of the data and “/Folder1/Folder2/” is the path of the data within the server “xxx.fx.co.jp”. In other words, the virtual URL is a combination of a typical location-based URL and a globally unique data ID. With such a combinational virtual URL also, the method of the above-described embodiment can be employed to search for the data, because the virtual URL contains the data ID. In addition, because the virtual URL also contains path information of the data within the server, the location of the data can be displayed on the basis of the location (directory), etc. (for example, a folder tree display). When the data item “uuid1” is moved to a directory “/Folder3/Folder4/” within the same server, the accurate virtual URL would be “http://xxx.fx.co.jp/Folder3/Folder4/uuid1”. However, even when a user accesses using the original virtual URL of “http://xxx.fx.co.jp/Folder1/Folder2/uuid1,” because the virtual URL contains the data ID, the user can accurately access the data “uuid1” in the directory “/Folder3/Folder4/.” In this case, it is assumed that the link information of the data “uuid1” in the data management section 12 is accurately updated in order to point to the data within the directory “/Folder3/Folder4/.” The data servers of the embodiment and the alternative embodiments are realized by executing a program describing functions and operations of the data server as described above in a general-purpose computer system. The program is typically provided in a state of being recorded on a computer-readable storage medium such as an optical disk such as a CD-ROM or a DVD-ROM, a magnetic disk such as a flexible disk, or a hard disk drive.

According to the present invention, because each data server detects another data server, and a data server having the requested data is searched through inquiry using a globally unique data identifier, the location of the data can be resolved without central management using a central management server.

While the invention has been described in conjunction with specific embodiments, it is evident to those skilled in the art that modifications may be made thereto in light of the foregoing description. Accordingly, it is intended that the appended claims cover all such modifications that fall within the spirit and scope of the invention.

The complete disclosure of Japanese Patent Application No. 2005-147656 filed on May 20, 2005, including the specification, claims, drawings, and abstract, is incorporated herein by reference in its entirety.

What is claimed is:

1. A data management system in which a data server cooperates with other data servers connected via a network, wherein each data server comprises:
a data management section in which one or more data items are stored;
a request processor section that searches the data management section for data item requested from a client, provides the requested data item to the client when the requested data item is found, and transmits a data inquiry to other data server on the network to detect a data server storing the requested data item when the requested data item is not found; and
a response section that searches, when receiving a data inquiry transmitted from another data server, the data management section for the requested data item and transmits to the another data server a result of the search.

2. The data management system according to claim 1, wherein
when the requested data item is not found in the data management section, the request processor section transmits, to the client, response information containing information of the requested data item and the detected data server which stores the requested data item.

3. The data management system according to claim 2, wherein
the data request from the client is performed using a virtual URL containing information of a data server and the requested data item, and
the response information contains a virtual URL having information of the requested data item and the detected data server which stores the requested data item.

4. The data management system according to claim 1, wherein
the data item is stored corresponding with globally unique data identifier, and
when a data item which is input to be stored in the data management section does not have the data identifier attached, the data management section attaches a globally unique data identifier to the data item and stores the data item.

5. The data management system according to claim 1, wherein
each data server transmits to the network a predetermined message and detects a device which transmits a predetermined response to the message as another data server which is a part of the data management system.

6. The data management system according to claim 1, wherein
each data server further comprises a server list storage section that stores information of other data servers which are a part of the data management system,
when the data item inquired from another data server is not found in the data management section, the response section transmits to the another data server information of other data servers stored in the server list storage section, and
when receiving information of the data servers from another data server in response to a data inquiry, the server list storage section updates the information stored in the server list storage section.

7. The data management system according to claim 1, wherein
each data server further comprises a location information management section that stores information of correspondence between data items and data servers which store the data items, and
when the data item requested from the client is not found in the data management section, the request processor section searches the location information management section for a data server which stores the requested data, and when the server is found, transmits the information of the found server to the client.

8. The data management system according to claim 7, wherein
when the data item inquired from another data server is not found in the data management section, the response section searches the location information management section for a data server which stores the inquired data and, when the server is found, transmits to the another data server the information of the found data server, and
when the request processor section receives, from another data server to which the data inquiry is transmitted, information of a data server as a response to the data inquiry, the request processor section transmits to the client information of the found data server.

9. The data management system according to claim 7, wherein
each data server further comprises:
a redirect information providing section that transmits to the client, when the requested data item is not found in the data management section, information of the requested data item, the detected data server which stores the requested data, and redirect origin which represents the data server which transmits the information, and causes the client to request the data item to the detected document server using the information;
a redirect origin storage section that stores information of the requested data item in correspondence to the redirect origin which is included in the data request from the client; and a location update information providing section that transmits, when a data server storing the requested data item is confirmed, location update information containing the information of the data server storing the requested data item to a data server indicated in the redirect origin information; wherein
the location information management section updates the information of the correspondence according to location update information received from another data server.

10. The data management system according to claim 9, wherein
when location update information received from another data server includes information of data item which is stored in the redirect origin storage section, the location information management section transfers the location update information to the data server corresponding to the data item in the redirect origin storage section.

11. The data management system according to claim 7, wherein each data server further comprises:
a redirect information providing section that transmits to the client, when the requested data item is not found in the data management section, information of the requested data item, the detected data server which stores the requested data, and redirect origin information which represents the data server which transmits the information, and causes the client to request the data item to the detected document server using the information;
a redirect origin storage section that stores information of the requested data item and the redirect origin which is included in the data request from the client; and
a location update information providing section that transmits, when the data request from the client contains redirect origin information and the requested data item is not found in the data management section, location update information indicating that the requested data item is not present in the requested data server, to a data server indicated in the redirect origin information; wherein
the location information management section updates the information of the correspondence in accordance with location update information received from another data server.

12. The data management system according to claim 11, wherein
when location update information received from another data server includes information of data item which is stored in the redirect origin storage section, the location information management section transfers the location update information to the data server corresponding to the data item in the redirect origin storage section.

13. The data management system according to claim 7, wherein
each data server further comprises:
an inquiry destination storage section that stores information of a data server which is a transmission destination of the data inquiry in correspondence to the requested data item which is a target of the data inquiry; and
a location update information providing section that transmits, when a data server which stores the requested data item is confirmed, to a data server which is an inquiry destination of the requested data item, location update information containing information of the data server which stores the requested data item; wherein
the location information management section updates the information of the correspondence in accordance with location update information received from another data server.

14. The data management system according to claim 8, wherein
each data server further comprises:
an inquiry destination storage section that stores information of a data server which is a transmission destination of the data inquiry in correspondence with the requested data item which is a target of the data inquiry; and
a location update information providing section that transmits location update information of the required data item, when the data server which has been indicated to be storing the requested data item by the data server which is the transmission destination of the data inquiry does not store the requested data, informing that the data server which has been indicated to be storing the requested data item does not store the requested data item, to the data server which is the transmission destination of the data inquiry; wherein
the location information management section updates the information of the correspondence in accordance with location update information received from another data server.

15. A data management server comprising:
a data management section in which one or more data items are stored;
a request processor section that searches the data management section for data item requested from a client, provides the requested data item to the client when the requested data item is found, and transmits a data inquiry to and receives a response from other data server on the network to detect a data server storing the requested data item when the requested data item is not found.

16. The data management server according to claim 15, wherein
when the requested data item is not found in the data management section, the request processor section transmits, to the client, response information containing information of the requested data item and the detected data server which stores the requested data item.

17. The data management server according to claim 16, wherein
the data request from the client is performed using a virtual URL containing information of a data server and the requested data item, and
the response information contains a virtual URL having information of the requested data item and the detected data server which stores the requested data item.

18. The data management server according to claim 15, wherein
the data item is stored corresponding with globally unique data identifier, and
when a data item which is input to be stored in the data management section does not have the data identifier attached, the data management section attaches a globally unique data identifier to the data item and stores the data item.

19. The data management server according to claim 15, wherein a predetermined message is transmitted to the network to detect other data server which is a part of the data management system.

20. The data management server according to claim 15, further comprising:
a server list storage section that stores information of other data servers which are a part of the data management system, wherein:
when the data item inquired from another data server is not found in the data management section, the response section transmits to the another data server information of other data servers stored in the server list storage section.

21. The data management server according to claim 15, further comprising:
a location information management section that stores information of correspondence between data items and data servers which store the data items, wherein
when the data item requested from the client is not found in the data management section, the request processor section searches the location information management section for a data server which stores the requested data, and when the server is found, transmits the information of the found server to the client.

22. The data management server according to claim 21, wherein
when the data item inquired from another data server is not found in the data management section, the response section searches the location information management section for a data server which stores the inquired data and, when the server is found, transmits to the another data server the information of the found data server.

23. The data management server according to claim 21, further comprising:
a redirect information providing section that transmits to the client, when the requested data item is not found in the data management section, information of the requested data item, the detected data server which stores the requested data, and redirect origin which represents the data server which transmits the information, and causes the client to request the data item to the detected document server using the information;
a redirect origin storage section that stores information of the requested data item in correspondence to the redirect origin which is included in the data request from the client; and
a location update information providing section that transmits, when a data server storing the requested data item is confirmed, location update information containing the information of the data server storing the requested data item to a data server indicated in the redirect origin information; wherein
the location information management section updates the information of the correspondence according to location update information received from another data server.

24. The data management server according to claim 23, wherein
when location update information received from another data server includes information of data item which is stored in the redirect origin storage section, the location information management section transfers the location update information to the data server corresponding to the data item in the redirect origin storage section.

25. The data management server according to claim 21,further comprising:
a redirect information providing section that transmits to the client, when the requested data item is not found in the data management section, information of the requested data item, the detected data server which stores the requested data, and redirect origin information which represents the data server which transmits the information, and causes the client to request the data item to the detected document server using the information;
a redirect origin storage section that stores information of the requested data item and the redirect origin which is included in the data request from the client; and
a location update information providing section that transmits, when the data request from the client contains redirect origin information and the requested data item is not found in the data management section, location update information indicating that the requested data item is not present in the requested data server, to a data server indicated in the redirect origin information; wherein
the location information management section updates the information of the correspondence in accordance with location update information received from another data server.

26. The data management server according to claim 25, wherein
when location update information received from another data server includes information of data item which is stored in the redirect origin storage section, the location information management section transfers the location update information to the data server corresponding to the data item in the redirect origin storage section.

27. The data management server according to claim 21, further comprising:
an inquiry destination storage section that stores information of a data server which is a transmission destination of the data inquiry in correspondence to the requested data item which is a target of the data inquiry; and
a location update information providing section that transmits, when a data server which stores the requested data item is confirmed, to a data server which is an inquiry destination of the requested data item, location update information containing information of the data server which stores the requested data item.

28. The data management server according to claim 21, further comprising:
an inquiry destination storage section that stores information of a data server which is a transmission destination of the data inquiry in correspondence with the requested data item which is a target of the data inquiry; and
a location update information providing section that transmits location update information of the required data item, when the data server which has been indicated to be storing the requested data item by the data server which is the transmission destination of the data inquiry does not store the requested data, informing that the data server which has been indicated to be storing the requested data item does not store the requested data item, to the data server which is the transmission destination of the data inquiry.

29. A data management method executed by a data server which forms a part of a data management system in cooperation with other data servers connected via a network, the method comprising:
storing one or more data items;
searching for data item requested from a client;
when the requested data item is found, providing the requested data item to the client; and
when the requested data item is not found, transmitting a data inquiry to other data server on the network to detect a data server storing the requested data item.

30. The data management method according to claim 29, further comprising:
when the requested data item is not found, transmitting to the client response information containing information of the requested data item and the detected data server which stores the requested data item.

31. The data management method according to claim 30, wherein
the data request from the client is performed using a virtual URL containing information of a data server and the requested data item, and
the response information contains a virtual URL having information of the requested data item and the detected data server which stores the requested data item.

32. The data management method according to claim 29, wherein
the data item is stored corresponding with globally unique data identifier, and
when a data item which is input to be stored in the data server does not have the data identifier attached, a globally unique data identifier is attached to the data and the data item is stored.

33. The data management method according to claim 29, further comprising:
transmitting to the network a predetermined message and receiving a response to the message to detect other data server which is a part of the data management system.

34. The data management method according to claim 29, further comprising:
storing information of other data servers which are a part of the data management system; and
when the data item inquired from another data server is not found, transmitting to the another data server information of other data servers stored in the server list storage section.

35. The data management method according to claim 29, further comprising:
storing information of correspondence between data items and data servers which store the data items;
when the data item requested from the client is not found in the data management section, searching the information of correspondence between data items and data servers which store the data items for a data server which stores the requested data; and
when the data server is found, transmitting the information of the found server to the client.

36. The data management method according to claim 35, further comprising:
when the data item inquired from another data server is not found, searching the information of correspondence between data items and data servers which store the data items for a data server which stores the inquired data item; and
when the server is found, transmitting to the another data server the information of the found data server.

37. The data management method according to claim 35, further comprising:
transmitting to the client, when the requested data item is not found, information of the requested data item, the detected data server which stores the requested data, and redirect origin which represents the data server which transmits the information, to cause the client to request the data item to the detected document server using the information;
storing information of the requested data item in correspondence to the redirect origin which is included in the data request from the client;
transmitting, when a data server storing the requested data item is confirmed, location update information containing the information of the data server storing the requested data item to a data server indicated in the redirect origin information; and updating the information of the correspondence according to location update information received from another data server.

38. The data management method according to claim 37, further comprising:
when location update information received from another data server includes information of data item corresponding to the stored redirect origin information, transferring the location update information to the data server represented by the redirect origin information.

39. The data management method according to claim 35, further comprising:
transmitting to the client, when the requested data item is not found, information of the requested data item, the detected data server which stores the requested data, and redirect origin which represents the data server which transmits the information, to cause the client to request the data item to the detected document server using the information;
storing information of the requested data item in correspondence to the redirect origin which is included in the data request from the client;
transmitting, when the data request from the client contains redirect origin information and the requested data item is not found, location update information indicating that the requested data item is not present, to a data server indicated in the redirect origin information; and
updating the information of the correspondence in accordance with location update information received from another data server.

40. The data management method according to claim 39, further comprising:
when location update information received from another data server includes information of data item corresponding to the stored redirect origin information, transferring the location update information to the data server represented by the redirect origin information.

41. The data management method according to claim 35, further comprising:
storing information of a data server which is a transmission destination of the data inquiry in correspondence to the requested data item which is a target of the data inquiry;
transmitting, when a data server which stores the requested data item is confirmed, to a data server which is an inquiry destination of the requested data item, location update information containing information of the data server which stores the requested data item.

42. 0The data management method according to claim 35, further comprising:
storing information of a data server which is a transmission destination of the data inquiry in correspondence to the requested data item which is a target of the data inquiry; and
transmitting location update information of the required data item, when the data server which has been indicated to be storing the requested data item by the data server which is the transmission destination of the data inquiry does not store the requested data, informing that the data server which has been indicated to be storing the requested data item does not store the requested data item, to the data server which is the transmission destination of the data inquiry.
